(19) United States
(12) Patent Application Publication
(10) Pub. No.: US 2025/0266929 A1
(43) Pub. Date: Aug. 21, 2025

(54) METHODS, SYSTEM, AND APPARATUS FOR JOINT ERROR CORRECTION CODING OF A SELF-DECODABLE PAYLOAD

(71) Applicant: Huawei Technologies Co., Ltd., Shenzhen (CN)

(72) Inventors: Huazi Zhang, Hangzhou (CN); Xiaoyan Bi, Shanghai (CN); Jianglei Ma, Ottawa (CA); Wen Tong, Ottawa (CA)

(21) Appl. No.: 19/094,228

(22) Filed: Mar. 28, 2025

Related U.S. Application Data
(63) Continuation of application No. PCT/CN2022/122852, filed on Sep. 29, 2022.

(51) Int. Cl. H04L 1/00; H04L 1/1812

(52) U.S. Cl. CPC H04L 1/0057; H04L 1/1819

(57) ABSTRACT

Joint error correction coding of multiple self-decodable payloads involves encoding multiple individual payloads with an error correcting code, to generate a codeword. The codeword includes multiple encoded blocks that respectively correspond to the individual payloads. One or more of the individual payloads or encoded blocks are self-decodable independently of other payloads or encoded blocks, and are also jointly decodable with one or more of the other payloads or encoded blocks.

### CROSS-REFERENCE TO RELATED APPLICATIONS

This application is continuation of International Application No. PCT/CN2022/122852, filed on Sep. 29, 2022, the disclosure of which is hereby incorporated by reference in its entirety.

### TECHNICAL FIELD

The present application relates to error correction coding for wireless communications.

### BACKGROUND

Resilience is a fundamental feature that needs to be addressed for so-called sixth generation (6G) communications. According to some technology visions of future factories and industries, for example, ultra-reliable and low latency wireless communications are a pivotal enabler for automated manufacturing on a massive scale.

Two trends are also observed in recent developments toward 6G. From a technological perspective, millimeter-wavelength (mmWave) communications and massive multiple input multiple output (MIMO) may become more prevalent because they can significantly expand current bandwidth resources. From a service perspective, a single communication device will likely need to support multiple services with different latency and reliability requirements.

A potential scenario emerges as multiple services converge into one physical wireless link. The purpose is to deliver multiple quality of service (QoS) levels to multiple services within only one wireless link. Given high carrier frequency and massive number of antennas in some communication systems, beamforming can be done more aggressively, enabling the convergence of multiple services into one wireless link. Meanwhile, these services may have very diverse key performance indicators (KPIs). For example, ultra-reliable low latency communications (URLLC), massive machine type communications (mMTC), enhanced mobile broadband (eMBB) and terabit per second (Tbps) communications may all be integrated in one link. This is challenging because different KPIs, for example for signal to noise ratio (SNR), fading, etc., must be supported under the same wireless channel.

### SUMMARY

The present disclosure encompasses embodiments that may be useful in addressing various technical shortcomings of current coding methods. With current technologies, there is a tradeoff between ultra-reliable communication and low latency communication. To achieve ultra-reliability, hybrid automatic repeat request (HARQ) has been employed in current systems to reduce the block error rate (BLER) level by several order of magnitudes. However, round-trip delay incurred by negative acknowledgement (NACK) signaling, re-scheduling and retransmission may not meet low-latency requirements in 6G. A simple workaround is to reduce code rate and modulation order, but this comes at a cost of spectrum efficiency, and is generally discouraged in system design.

This tradeoff may also present in typical joint coding methods, where different payloads are mapped according to their priorities and encoded into one long codeword. Although this may provide unequal error protection to support various reliability requirements and deliver multiple QoS to multiple services within one wireless link, decoding cannot begin until the entire long codeword has been received, which can incur extra delay.

Providing good coding performance in mixed-service and low-latency communication applications remains a challenge. For example, HARQ-based approaches may incur long round-trip delay and might not be able to meet low latency requirements, and the above-referenced approach to joint coding does not support individual decoding of different payloads until all payloads in a long codeword are received.

In some embodiments of the present disclosure, retransmission latency may be mitigated or avoided by supporting further decoding operations after a decoding failure of a delay-sensitive payload. Requesting a retransmission may not be feasible in some applications because a resulting round-trip delay may exceed a maximum tolerable delay, and further decoding operations after decoding failure may avoid a retransmission request. For example, after a decoding failure, a receiver may carry out a second decoding attempt without requesting a retransmission. In this example, the extra decoding latency incurred during a second decoding attempt is likely to be much smaller than the extra latency of round-trip delay for a retransmission.

Joint coding according to some embodiments may help enhance performance, in that multiple services may in effect augment each other in joint coding.

Unequal error protection may be provided for different payloads, such as payloads related to different services. Encoding and decoding of a joint codeword, for example, may support different error protection levels for different services. Consider an application that involves URLLC and eMBB services, in which target BLER of a URLLC payload should be at least one order of magnitude lower than that of an eMBB payload. Embodiments disclosed herein may enable such unequal error protection.

Self-decodability may also or instead be provided, for each individual service for example. To support different latency requirements of multiple services, each service may be self-decodable based on its own proportion of code bits, or in other words based on its own corresponding part of a long codeword. For example, it may be possible to decode a shorter URLLC payload once some, but not all, code bits (such as log-likelihood ratios or LLRs) are received. Payloads may thus be self-decodable, without having to wait for the reception of an entire, longer, joint codeword.

According to an aspect of the present disclosure, a method involves transmitting, by a first communication device to a second communication device in a wireless communication network, a codeword that comprises a plurality of encoded blocks generated by encoding respective individual payloads with an error correction code. The plurality of encoded blocks comprises a self-decodable encoded block. The self-decodable encoded block is decodable independently of other encoded blocks of the plurality of encoded blocks, and is also decodable jointly with one or more of the other encoded blocks of the plurality of encoded blocks of the codeword.

A related method may involve receiving, from a first communication device by a second communication device in a wireless communication network, a codeword as described, which include a plurality of encoded blocks corresponding to respective error correction coded individual payloads. As above, the plurality of encoded blocks comprises a self-decodable encoded block that is decodable independently of other encoded blocks of the plurality of encoded blocks, and is also decodable jointly with one or more of the other encoded blocks of the plurality of encoded blocks of the codeword.

Another method involves obtaining and encoding a plurality of individual payloads to generate a codeword, and outputting the codeword. The encoding involves encoding each of the individual payloads with an error correction code to generate the codeword. The codeword comprises a plurality of encoded blocks corresponding to respective individual payloads of the plurality individual payloads. The plurality of encoded blocks comprises a self-decodable encoded block that is not only decodable independently of other encoded blocks of the plurality of encoded blocks, but is also decodable jointly with one or more of the other encoded blocks of the plurality of encoded blocks of the codeword.

According to a related embodiment, a method involves: decoding, from a codeword that comprises a plurality of encoded blocks corresponding to respective error correction coded individual payloads, the individual payloads; and outputting the individual payloads. Again, the plurality of encoded blocks comprises a self-decodable encoded block that is not only decodable independently of other encoded blocks of the plurality of encoded blocks, but is also decodable jointly with one or more of the other encoded blocks of the plurality of encoded blocks of the codeword.

In apparatus embodiments, an apparatus may include a processor and a non-transitory computer readable storage medium that is coupled to the processor. The non-transitory computer readable storage medium stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

For example, the programming may include instructions to, or to cause a processor to: transmit, by a first communication device to a second communication device in a wireless communication network, a codeword that comprises a plurality of encoded blocks generated by encoding respective individual payloads with an error correction code.

Programming may include instructions to, or to cause a processor to: receive, from a first communication device by a second communication device in a wireless communication network, a codeword that comprises a plurality of encoded blocks corresponding to respective error correction coded individual payloads.

The programming, in another embodiment, may include instructions to, or to cause a processor to: obtain and encode each of a plurality of individual payloads to generate a codeword, and output the codeword. The individual payloads are each encoded with an error correction code to generate the codeword, so that the codeword comprises a plurality of encoded blocks corresponding to respective individual payloads of the plurality individual payloads.

According to yet another embodiment, programming includes instructions to, or to cause a processor to: decode, from a codeword that comprises a plurality of encoded blocks corresponding to respective error correction coded individual payloads, the individual payloads; and output the individual payloads.

In the above-referenced apparatus and computer program product embodiments, as in the method embodiments, the plurality of encoded blocks comprises a self-decodable encoded block that is decodable independently of other encoded blocks of the plurality of encoded blocks, and is further decodable jointly with one or more of the other encoded blocks of the plurality of encoded blocks of the codeword.

According to yet another embodiment, a system comprises a first communication device and a second communication device. The first communication device is configured to transmit a codeword comprising a plurality of encoded blocks generated by encoding respective individual payloads with an error correction code. The plurality of encoded blocks comprise a self-decodable encoded block. The second communication device is configured to receive, from the first communication device, the codeword comprising the plurality of encoded blocks. The second communication device is further configured to decode the self-decodable encoded block to obtain an individual payload from the codeword.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram illustrating an example multi-service scenario.

FIG. 6 is a block diagram illustrating self-decoding and joint-decoding in the event of a self-decoding failure.

FIG. 7 is a block diagram illustrating a robot arm that includes a video device and two joints, and communicates with a base station.

FIG. 8 is a block diagram illustrating an example code block and encoded symbols according to an embodiment.

FIG. 9 is a block diagram illustrating an example code block and encoded symbols according to another embodiment.

FIG. 10 is a block diagram illustrating an example code block and encoded symbols according to a further embodiment.

FIG. 11 is a block diagram illustrating sequential coupling of bits between individual payloads.

FIG. 12 is a block diagram illustrating multi-to-one coupling of bits between individual payloads.

FIG. 13 is a flow diagram illustrating example methods according to embodiments.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

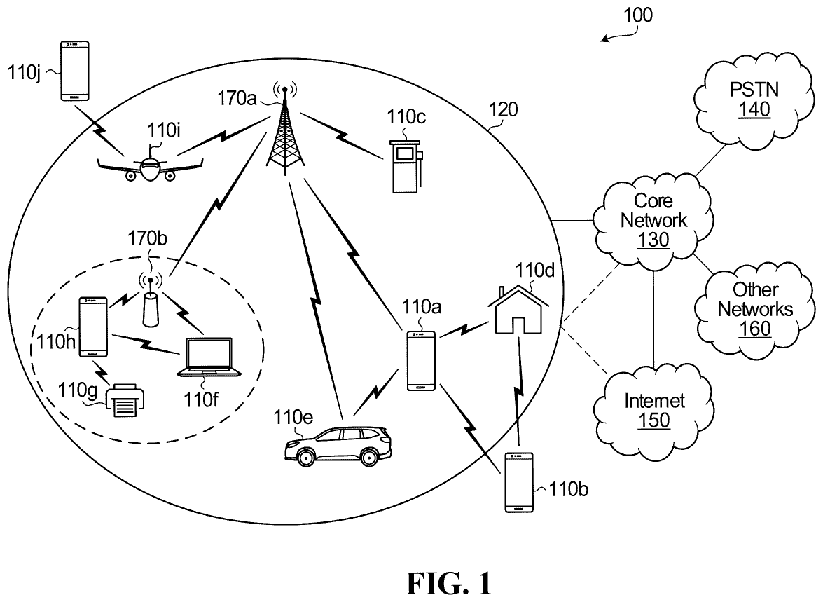

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

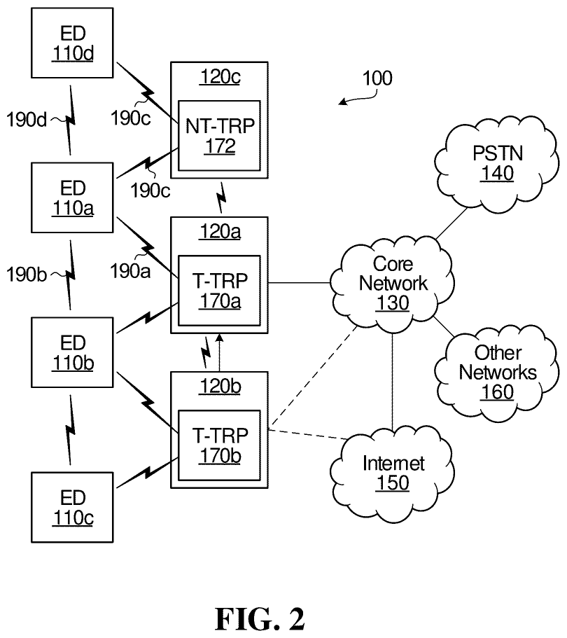

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

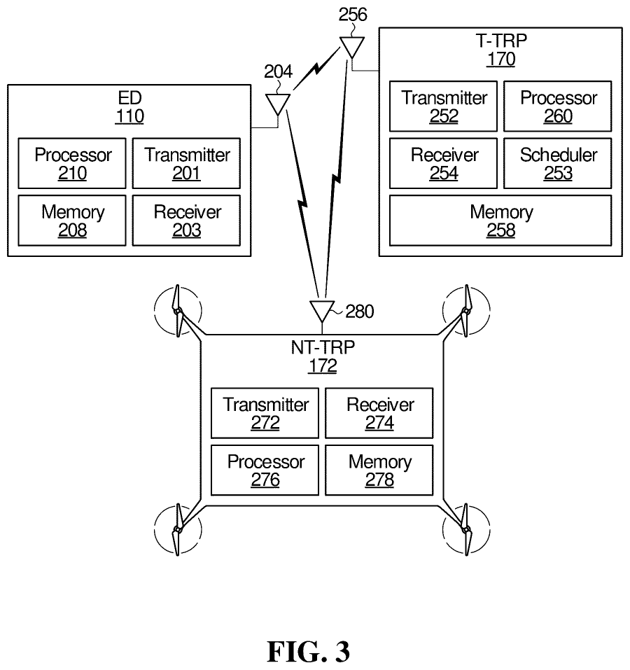

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

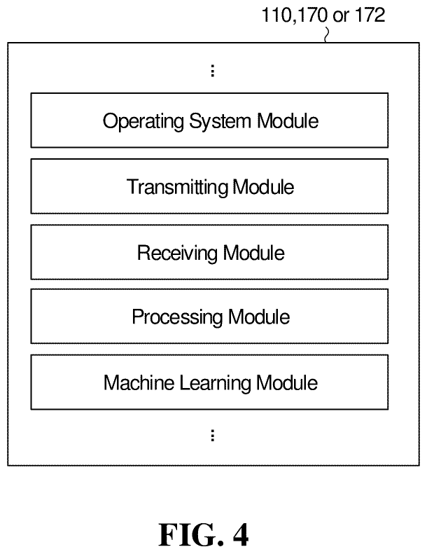

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

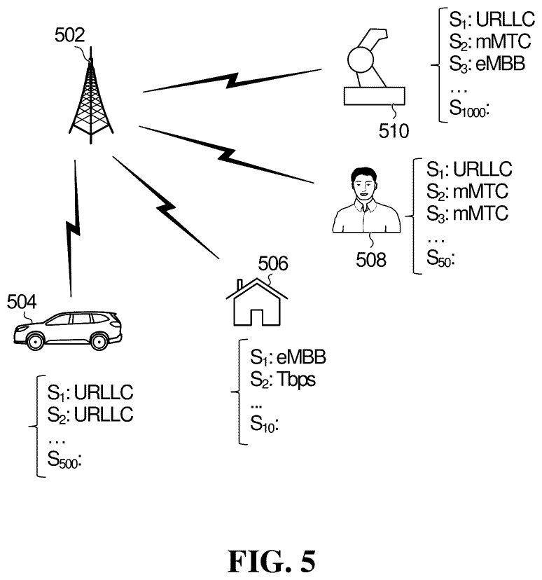

As referenced above, multiple services may converge or be integrated into one physical wireless link, and these services may have diverse key performance indicators (KPIs). FIG. 5 is a block diagram illustrating an example multi-service scenario, in which services integrated into one link may include any of URLLC, mMTC, eMBB, and Tbps services. In FIG. 5, communication devices include a network device 502, a vehicle-based device represented at 504, a home-based or other premises-based device represented at 506, a user device represented at 508, and an industrial or machine-based device represented at 510, each with example services as shown.

The present disclosure is not limited to these or any other types of devices or services. FIG. 5 is intended to provide one example scenario in which embodiments disclosed herein may be particularly useful. More generally, disclosed embodiments may be implemented, for example, in next-generation mobile and wireless network services, cloud and edge computing services, and sensing services. Some embodiments may be particularly useful for automated manufacturing systems in smart factories, and/or other intelligent vertical scenarios such as ports, delivery systems, and medical systems. These possible applications of embodiments are also illustrative and non-limiting examples.

A multi-service scenario, such as the scenario shown by way of example in FIG. 5, may be considered a form of intra-user equipment (UE) multiple access (MA). Intra-UE MA refers to concurrent transmissions of multiple services from one terminal device.

One aspect of the present disclosure relates to adding a new procedure between a decoding failure and a request for a retransmission. This may be achieved, for example, by integrating various services into a single block or payload for encoding, with awareness of different service priorities. Service priorities may refer to any of various properties or characteristics, such as any of one or more of target BLER, latency, and sources for example. Some embodiments involve a novel channel coding design to support both self-decodability of one or more individual payloads, and enhanced joint decodability of such individual payloads. Individual payloads may also be referred to as blocks, constituent payloads, or short or shorter messages or payloads, and are part of a larger payload. A larger payload may also be referred to as a longer or payload, a combined payload, or a code block. Payloads, messages, and code blocks, as used herein refer to bits before channel encoding or after channel decoding.

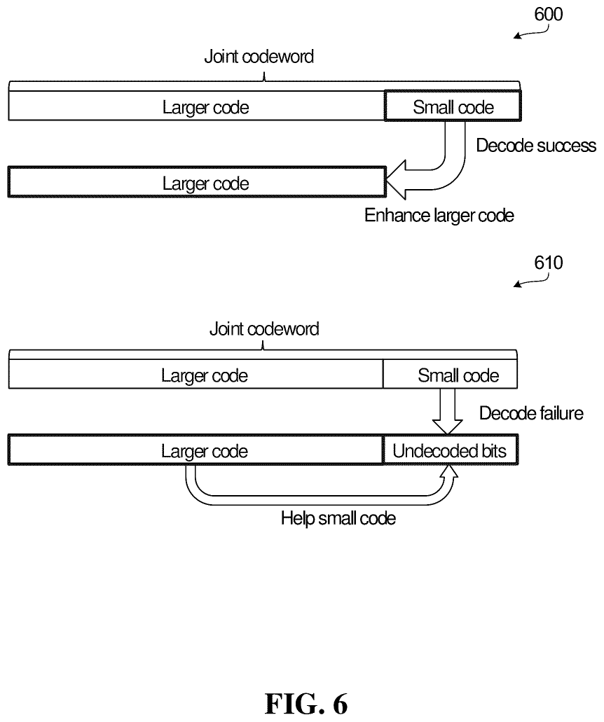

In one possible self-decodable joint coding design, each of one or more individual payloads, which may correspond to different services for example, can be self-decoded, and at the same time support joint decoding to further enhance performance. FIG. 6 is a block diagram illustrating self-decoding at 600, and joint-decoding in the event of a self-decoding failure, at 610.

As an example, several smaller or shorter messages may be embedded or otherwise combined into a longer code block or payload, also referred to herein as a combined payload. These smaller messages are self-decodable, meaning that they can be decoded after collecting only a subset of code bits, or symbols, or LLRs, associated with a longer codeword rather than the entire, longer codeword. The subset of code bits is also a standalone short code or codeword that is decodable on its own.

Two or more of such smaller messages are also jointly-decodable. The subsets of code bits corresponding to smaller messages that are jointly-decodable combine into a longer code. This may be accomplished through what is referred to herein as “coupling” between bits from multiple messages.

For example, some or all of the bits of a first message may be copied and combined with bits of a second message. The combined message is then encoded into a joint codeword. In this example, bits from the first message may be directly copied and appended to or otherwise combined with the bits of the second message. Another possible option is to first transform bits from the first message, by multiplying them with a binary matrix for example, and then appending the transformed bits to, or otherwise combining the transformed bits with, the bits of the second message.

Although this example refers to information bit (message) coupling, it is feasible to also or instead use coded bits for coupling. In the case of systematic codes, for example, message bits are also part of code bits, and thus the two alternatives, for information bit coupling or code bit coupling, become much the same.

Some embodiments support multiple decoding attempts before requesting retransmission. Joint decoding, for example, may in effect be inserted or attempted between a decoding failure and a retransmission request.

As an example, consider an embodiment that involves a three decoding attempt transmission approach. In a first decoding attempt 600, a receiver receives a codeword and decodes a first self-decodable payload of the codeword after receiving a corresponding minimum of required code bits. If the decoding of the first payload is successful, then the correctly decoded bits can be used to enhance decoding performance for a second payload of the codeword, after a corresponding minimum required number of code bits for decoding of the second payload are received.

A second decoding attempt 610 is made if decoding of the first payload fails. Instead of immediately requesting a retransmission, the receiver instead proceeds to attempt to jointly decode the first payload with the second payload. After decoding of the second payload, regardless of whether there is success or failure of the second payload decoding, joint decoding can increase probability that the first payload will be successfully decoded.

In this example, if decoding of the first payload still fails after the second (joint) decoding attempt, then the receiver requests a retransmission (not shown) from the transmitter. This will incur some delay, but with a retransmission the receiver can make at least a third decoding attempt. With a retransmitted codeword, multiple decoding attempts may be made, to self-decode from the retransmitted codeword, jointly decode from parts of the retransmitted codeword, and/or jointly decode using both the previously received codeword and the retransmitted codeword.

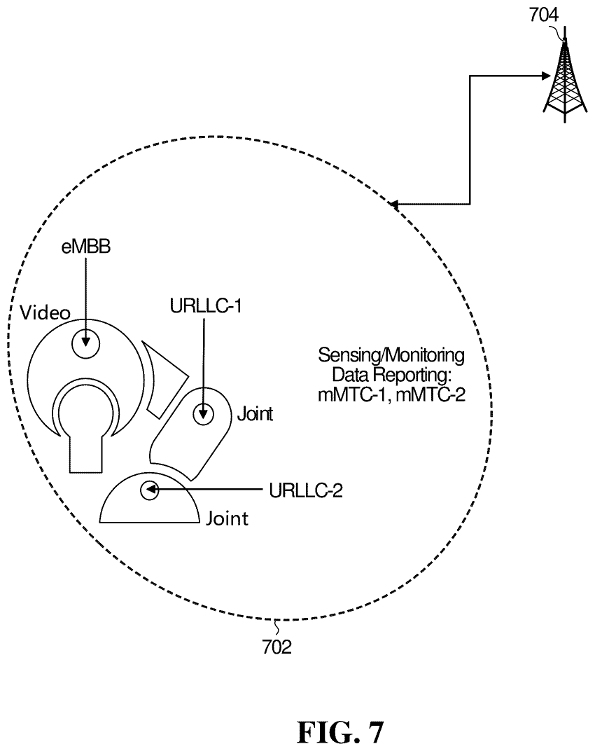

Consider now an example in which a device such as a robot arm communicates with a network device such as a base station, and supports URLLC, eMBB and mMTC services. Suppose that the device's video stream data transmissions belong to an eMBB service, signaling for controlling each of one or more joints of the robot arm belongs to a URLLC service, and delay-insensitive sensing or monitoring data reporting belongs to an mMTC service. FIG. 7 is a block diagram illustrating this example, in which a robot arm 702 includes a video device and two joints, and communicates with a BS 704.

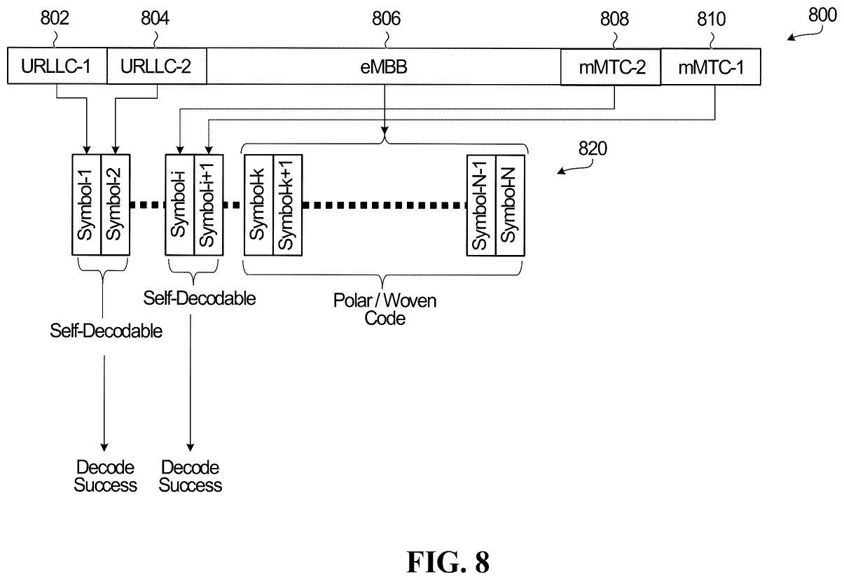

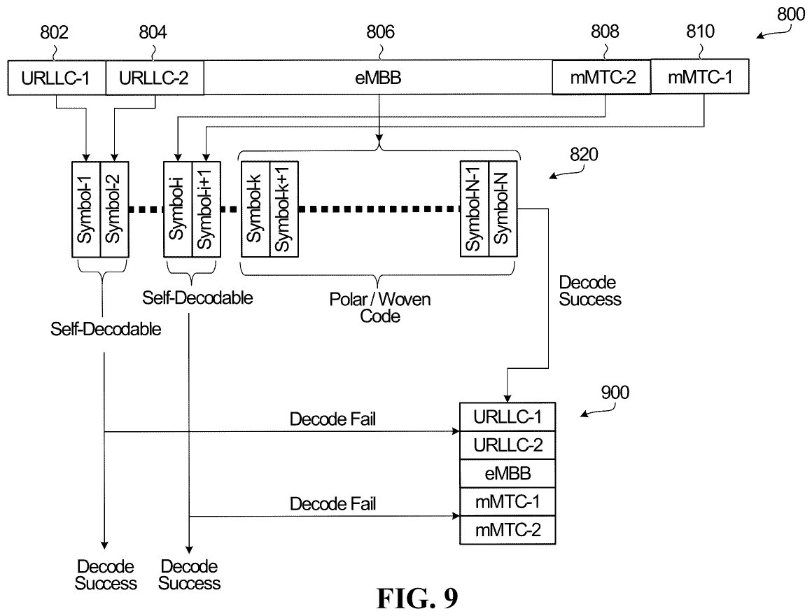

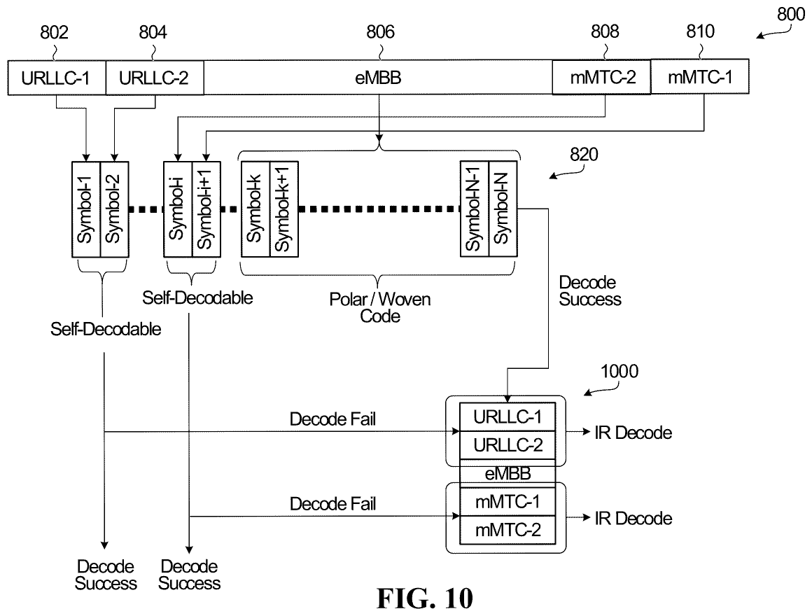

FIG. 8 is a block diagram illustrating an example code block and encoded symbols according to an embodiment. In FIG. 8, and similarly in FIGS. 9 and 10 described below, 800 represents a code block or combined payload that includes individual payloads 802, 804, 806, 808, 810. The individual payloads 802, 804, 806, 808, 810 include payloads that are associated with different services in the example shown. The code block 800 is channel encoded to generate a codeword 820 for transmission. The codeword 820 is generated by encoding the individual payloads with an error correction code. Polar code or woven code is illustrated for the eMBB individual payload as an example. Other codes, including different codes for different individual payloads, are possible. The codeword 820 is also shown as comprising N symbols, but symbols are intended solely as an illustrative example of parts of a codeword. The arrangement of symbols shown at 820 is also an example that is intended to illustrate one possible decoding order. FIG. 8, and similarly FIGS. 9 and 10, should be interpreted accordingly.

A code block as shown at 800 may be referred to as a combined or joint code block, because it includes individual payloads, blocks, or bits, which correspond to URLLC, eMBB and mMTC services in the example shown. The URLLC, eMBB, and mMTC encoded symbols represent transmitted or received information about code bits, which are part of a codeword. The encoded symbols may be referred to by any of various names or terms, such as packets, blocks, codes, sub-codewords, signals, LLRs, resource elements (REs), etc. For ease of reference, the present disclosure refers primarily to encoded symbols or encoded blocks in referring to parts of a codeword.

In the codeword 820, the URLLC, eMBB, and mMTC encoded symbols are self-decodable. Once code bits for each encoded symbol are received, that symbol can be decoded even though, in the case of the URLLC and the mMTC encoded symbols in the example shown, the entire codeword 820 has not yet been received. A self-decodable symbol may be decoded independently from other encoded symbols, in a first decoding attempt for example, and is also jointly-decodable with one or more other encoded symbols, which may (but need not necessarily be) self-decodable symbols, as disclosed herein.

Self-decodable and jointly-decodable may be referenced in the context of data before or after channel coding. For example, a short code or block that is part of a longer codeword may be considered self-decodable in that the block is decodable on its own, independently of the remainder of the longer codeword. The data that was encoded to generate that short code or block, also referred to herein as an individual payload for example, may be considered self-decodable in that the individual payload is self-decodable from the short code or block. Whether in the context of unencoded payloads or encoded symbols or packets, for example, decodable is intended to mean the same thing, specifically that individual payloads and a combined payload can be decoded from a codeword, or equivalently a codeword can be decoded to recover individual payloads and a combined payload. In other words, a payload (information bits) and a coded block or packet (code bits) can be deterministically transformed to/from each other. A payload/information bits or a code packet/code bits may be referred to as being decodable, or as being encodable.

In FIG. 8 for example, URLLC individual payloads 802, 804 are placed in the beginning of the code block 800, so that these delay-sensitive payloads may be decoded first, followed by an eMBB individual payload 806, and then mMTC individual payloads 808, 810.

At a receiver, a decoder first attempts to decode the URLLC encoded symbols or short packets, labelled Symbol-1 and Symbol-2 in FIG. 8. For illustrative purposes, the URLLC individual payloads are shown as being encoded into respective self-decodable encoded symbols, but in other embodiments encoding is based on service type, and 802, 804 are treated as one individual payload and are self-decodable together as one individual payload. If a URLLC packet can be successfully decoded, then URLLC bits, from that packet or the individual payload decoded from that packet, can assist or augment decoding of one or more other packets, or more generally one or more other blocks or sub-codewords of the long codeword 820. For example, encoded or decoded URLLC bits may be coupled in the eMBB individual payload 806, and/or in the eMBB encoded packet(s), including Symbol-k, Symbol-k=1, . . . , Symbol-N-1, Symbol-N in the example shown. The coupled bits can augment decoding of the eMBB packet(s). After URLLC decoding, the decoder may then either decode the eMBB packet(s), or decode the mMTC packet(s), including Symbol-i and Symbol-i+1 in the example shown. If the decoder attempts to decode the eMBB packet(s) after URLLC decoding and the eMBB decoding is successful, then the mMTC packet(s) can be decoded with lower error probability based on any coupled eMBB bits. Otherwise, if decoding of the mMTC packet(s) is attempted after URLLC decoding and are successfully decoded, then the eMBB packet(s) can be decoded with even lower probability based on any URLLC and/or mMTC bits coupled in the eMBB individual payload 806 or the eMBB packet(s). In the example shown in FIG. 8, the arrangement of encoded packets at 820 illustrates an embodiment that supports URLLC decoding, then mMTC decoding, and then eMBB decoding, but this is not the only possible decoding order.

Augmented decoding of a second packet, which may include one or more eMBB packets in the examples above, after the successful decoding of a first packet, which may include one or more URLLC packets and/or one or more mMTC packets in the examples above, is enabled by coupling of information bits and/or encoded bits between individual payloads and/or packets. In the case of coupled information bits, for example, a packet for which decoding is augmented will have been generated from fewer information bits of an individual payload, but the packet length remains the same, which results in a lower code rate. In the case of coupled code bits, a packet for which decoding is augmented will effectively have shortened code bits that are pre-known to the decoder, which also in effect results in a lower code rate. In both cases, whether information bits, coded bits, or both are coupled between packets, the code rate for augmented decoding, of eMBB packet(s) in the examples described with reference to FIG. 8, can be reduced. This can provide improved decoding performance by increasing the probability of successful decoding.

It should be noted that the packet(s) for which inter-packet coupling provides or supports augmented decoding may also be self-decodable. Coupling of bits between packets does not mean that augmented decoding must rely on prior successful decoding of coupled bits. For example, the eMBB packets(s) in the examples described with reference to FIG. 8 may be self-decodable regardless of whether decoding of the URLLC and/or mMTC packets was successful.

FIG. 9 is a block diagram illustrating an example code block and encoded symbols according to another embodiment. The code block 800 and encoded symbols 820 are the same as those shown in FIG. 8, but FIG. 9 illustrates different decoding at 900, which may be referred to as HARQ-less URLLC. If a self-decodable packet (for URLLC for example) fails to decode, then instead of requesting a retransmission, the receiver may proceed to decode another self-decodable packet (for eMBB or mMTC, with mMTC being shown as an example in FIG. 9). If the latter self-decodable packet is successfully decoded, then the code rate of the former packet can be reduced based on coupled bits from the latter packet, resulting in improved performance. Another option is that if a self-decodable packet (for URLLC for example) fails to decode, then instead of requesting a retransmission, the receiver may proceed to jointly decode the entire joint codeword 820 to recover the entire code block 800. If the joint codeword 820 is successfully decoded, then all of the bits at 800 can be correctly recovered. In one example shown in FIG. 9 at 900, if both URLLC decoding and mMTC decoding fail, then joint decoding can still be successful.

There may be different modes for coupling between encoded blocks such as URLLC symbols and eMBB symbols. In a mode or approach that could be referred to as tight coupling, for example, the coupling is within one time slot or one combined or joint code block 800 as shown in FIG. 9. To enable joint decoding, there is coupling between individual payloads or encoded blocks within one code block 800 or codeword 820. Another mode or approach may be referred to as loose coupling, according to which the coupling is between two different time slot or joint code blocks, such as two consecutive time slots or code blocks. Tight coupling may be preferred, for example, because it enables joint decoding based on a single slot or parts of a single joint codeword rather than multiple slots or parts of multiple codewords.

FIG. 10 is a block diagram illustrating an example code block and encoded symbols according to a further embodiment. The code block 800 and encoded symbols 820 are the same as those shown in FIGS. 8 and 9, but FIG. 10 illustrates different decoding at 1000, which may be referred to as HARQ-less URLLC with incremental redundancy (IR) combining. In some embodiments, there may be multiple decoding attempts without requesting retransmission, such as shown in FIGS. 8 and 9 above, and if those decoding attempts fail, then a receiver may request retransmission using incremental redundancy HARQ. This type of approach may still be referred to as “HARQ-less” in the context of the multiple decoding attempts before a first retransmission request is transmitted by a receiver and received by a transmitter, and HARQ-less URLLC with IR as referenced above adds the option of a retransmission request after multiple unsuccessful decoding attempts.

A retransmission preferably contains incremental redundancy information such as incremental code bits for the first message (URLLC in the example shown in FIG. 10), because successful decoding of the first message will increase the chance of successful decoding of subsequent messages. Optionally, the retransmission may also or instead contain incremental redundancy information such as incremental code bits for the subsequent messages, in order to further enhance decoding performance. IR decoding based on incremental codes bits is generally indicated at 1000 by “IR Decode”, for both URLLC and mMTC in the example shown.

After receiving the retransmitted code bits, the receiver may perform similar decoding attempts as described by way of example above.

Regarding requests and retransmission, consider a conventional HARQ approach, which is enabled by acknowledgement (ACK) and/or negative acknowledgement (NACK) signaling, and up to four redundant versions (RV1, RV2, RV3, RV4) for retransmission options. NACK signaling may be considered a form of retransmission request, in response to which a retransmission that includes a redundant version of previously transmitted data is sent by a transmitter. In this type of approach, a NACK would be sent by a receiver after a first decoding failure.

According to embodiments disclosed herein, a second decoding attempt (i.e., “HARQ-less”) is made before retransmission is requested, via NACK signaling or otherwise. This may involve behaviors or features at either or both of an encoder/transmit device and a decoder/receive device.

For example, a new type of signaling may be provided to support multiple decoding attempts before retransmission. ACK signaling may be transmitted from a decoder or receiving device and received by an encoder or transmit device in multi-attempt embodiments to acknowledge decoding success. In addition to, or possibly instead of, conventional NACK signaling, new signaling to indicate a decoding failure after a second (or subsequent) attempt may be provided. Simply for ease of reference, such signaling is called “NACK-2” signaling herein, but may be called by different names. With NACK-2 signaling indicating decoding failure after multiple decoding attempts, an encoder or transmit device can determine whether a negative acknowledgement is from a first or second (or subsequent) decoding failure. The encoder or transmit device may then choose to prioritize retransmission(s) for any decoder or receive device that sent NACK-2 signaling, and delay retransmission(s) for other devices that sent NACK signaling.

In these NACK/NACK-2 examples, whether to request retransmission using NACK or NACK-2 is left for a decoder or receiving device to decide. A device can potentially send both NACK and NACK-2 after multiple decoding failures, or entirely skip the NACK for the first decoding failure and not send NACK at all. How to exploit the difference between NACK and NACK-2 is left for the transmit device to decide. It can prioritize retransmission for NACK-2 in the case of resource constraints, for example, or treat NACK and NACK-2 equally in the case of sufficient resources.

Retransmission procedures may also or instead be different. For example, in addition to, or instead of, redundant versions RV1 to RV4 in the conventional HARQ approach outlined above, there may be one or more new redundant versions or joint retransmission versions to indicate whether a retransmission is a standalone RV (as in the conventional example above), or embedded in an incoming payload or packet (for example, in an incoming eMBB packet to enable joint decoding of a URLLC packet or payload) through joint coding. This latter type of embedded retransmission may be referred to as a joint retransmission version or J-RV, for example, to enable a decoder or receive device to determine whether a retransmission is a standalone RV or a J-RV.

FIGS. 8 to 10, like other drawings herein, provide illustrative and non-limiting examples. Variations are possible; for example, individual payloads for different packets can be ordered according to any of various criteria, such as their priority or urgency. It may be preferable to decode individual payloads for more urgent services such as URLLC first, and accordingly those individual payloads may be at the beginning of a combined payload as shown. Code bits for those individual payloads will then be transmitted, received, and decoded before others.

Other criteria may also or instead be taken into account. For example, individual payloads and/or corresponding packets can be ordered according to data or packet size. Packets for smaller messages (fewer information bits) or fewer coded bits, for example, can be placed, transmitted, and received/decoded first. This may enable a smaller decoding LLR buffer because the first-received packets can be quickly decoded and the corresponding LLRs can then be flushed from the buffer.

There are several possible ways to provide or support self-decoding and joint-decoding. For example, payloads or packets can be coupled according to a sequence or chain structure, or coupled in a star structure.

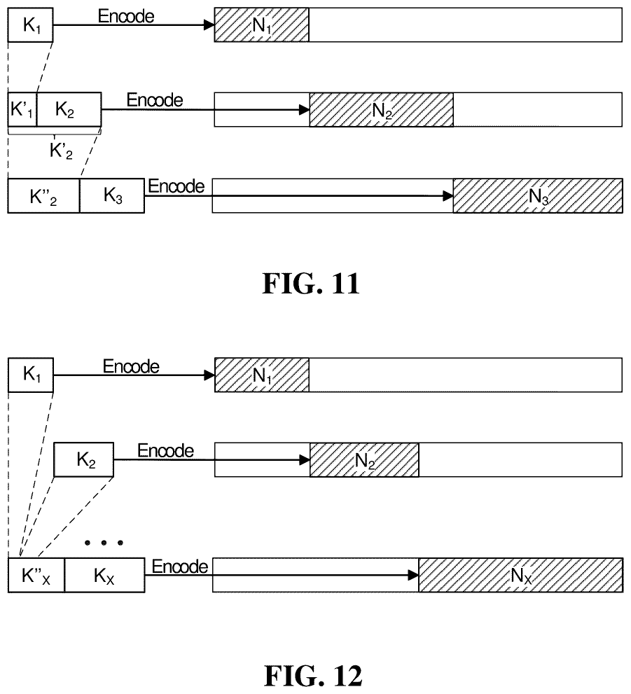

FIG. 11 is a block diagram illustrating sequential coupling of bits between individual payloads, according to a sequence or chain structure. This type of encoding approach to provide or support self-decoding and joint-decoding may also or instead be referred to as successive embedding, to capture the notion that information bits from one individual payload are embedded or otherwise combined with information bits of another individual payload.

In the example shown in FIG. 11, K₁ information bits (associated with a URLLC service, for example) are encoded into N₁ code bits, for a code rate of R₁=K₁/N₁. Of the K₁ information bits, K′₁ bits (K′₁≤K₁) are prepended to K₂ additional bits of a different individual payload (for eMBB for example). Embedded bits may be prepended as shown, but in other embodiments embedded bits may be appended to or otherwise combined with information bits of a different individual payload. The combined K′₂=K′₁+K₂ bits are encoded into N₂ code bits, for a code rate of R₂=K′₂/N₂>R₁. K″₂ bits from the K′₂ (K″₂≤K′₂) are embedded, by prepending in the example shown, with K₃ additional bits from a different individual payload (for mMTC for example), and the resultant K″₃=K″₂+K₃ bits are encoded into N₃ code bits. The code rate is R₃=K″₃/N₃>R₂. A joint codeword includes the N₁ code bits, the N₂ code bits, and the N₃ code bits. This type of sequential or successive embedding may be repeated for more individual payloads, or in some embodiments there may be fewer than three individual payloads.

FIG. 12 is a block diagram illustrating what may be referred to as multi-to-one coupling of bits between individual payloads, according to a star structure. This type of encoding approach to provide or support self-decoding and joint-decoding may also or instead be referred to as multi-to-one embedding, in which information bits from multiple different individual payloads are embedded or otherwise combined with information bits of one other individual payload.

In the example shown in FIG. 12, K₁ information bits (associated with a URLLC service, for example) are encoded into N₁ code bits for a code rate of R₁=K₁/N₁, and K₂ information bits (associated with an mMTC service, for example) are encoded into N₂ code bits for a code rate of R₂=K₂/N₂. This may be repeated if there are more than two individual payloads to be coupled to another individual payload. K′₁ bits of the K₁ information bits (K′₁≤K₁), K′₂ bits of the K₂ information bits (K′₂≤K₂), and some or all information bits of any other individual payloads that are to be coupled, are embedded with Kₓ additional bits of a different individual payload (for eMBB for example). Embedded bits may be prepended as shown, but in other embodiments embedded bits may be appended to or otherwise combined with information bits of a different individual payload. The combined K′ₓ=K″ₓ+Kₓ bits are encoded into Nₓ code bits, for a code rate of Rₓ=K′ₓ/Nₓ>R₁, Rₓ>R₂, and so on.

FIGS. 11 and 12 illustrate examples of coupling, in which one or more common bits couple one or more self-decodable encoded blocks with one or more other encoded blocks. In FIG. 11, common bits are successively embedded, between respective individual payloads that are encoded to generate a self-decodable encoded block (the K₁-bit block for example) and one or more other encoded blocks in a codeword, according to a sequence of the respective individual payloads in a combined payload corresponding to the codeword. In FIG. 12, the common bits are embedded, into one individual payload (at the bottom of FIG. 12 in the example shown) that is encoded to generate one encoded block, from respective individual payloads that are encoded to generate a self-decodable encoded block (the K₁-bit block for example) and another encoded block (the K₂-bit block for example).

These are examples only, and other types of coupling between individual payloads and/or encoded packets are possible, including a coupling approach that combines the sequential or successive coupling of FIG. 11 with the multi-to-one coupling of FIG. 12. For example, in such a mixed coupling approach, a first individual payload may be encoded according to sequential coupling and a second individual payload may be encoded according to multi-to-one coupling, or vice-versa.

Coupling is not in any way limited to common bits between different individual payloads, and common bits may also or instead be common to encoded blocks. For example, in an approach similar to the example in FIG. 11 but applied to coded bits, common bits may be successively embedded between a self-decodable encoded block (the N₁-bit block for example) and one or more other encoded blocks according to a sequence of the self-decodable encoded block and the other encoded block(s) in a codeword. Similarly, considering multi-to-one coupling of encoded blocks, common bits may be embedded, into one encoded block (the Nₓ-bit block at the bottom of FIG. 12 for example) that is encoded to generate one encoded block, from the self-decodable block (the N₁-bit block for example) and one or more other encoded blocks (such as the N₂-bit block for example).

As another example, embedding may be applied between only some and not all individual payloads, and/or a combination of these two approaches may be applied.

Variations in encoding of information bits are also possible.

In encoding information bits in FIGS. 11 and 12, all information bits may be encoded using the same or similar types of codes, or different codes may be used for different individual payloads. This may also or instead be applied more generally to coding of individual payloads.

A common code type for all individual payloads may be more suitable for coupling between individual payloads or packets. Soft-output iteratively decoded codes, for example, include convolutional codes, turbo codes, low density parity check (LDPC) codes, product codes, and woven codes. Any of these can be jointly decoded. For example, after decoding two codewords independently, soft information about shared/coupled bits can be exchanged (in an inter-code iteration) between two codes before further decoding. Hard-output successively decoded codes include polar codes, polarization-adjusted convolutional (PAC) codes, Reed-Muller (RM) codes, Bose-Chaudhuri-Hocquenghem (BCH) codes, and Reed-Solomon (RS) codes. These codes can also be decoded using joint successive cancellation. For example, after decoding one codeword, its shared/coupled bits can be cancelled from another codeword, and then that other codeword can be decoded. Because codes belonging to any one type have more compatible decoders, they are more conveniently decoded together. Therefore, it may be preferable to use codes of the same type (i.e., soft or hard) for individual payloads that are part of the same combined payload. However, it is also possible to use codes of different types in other embodiments.

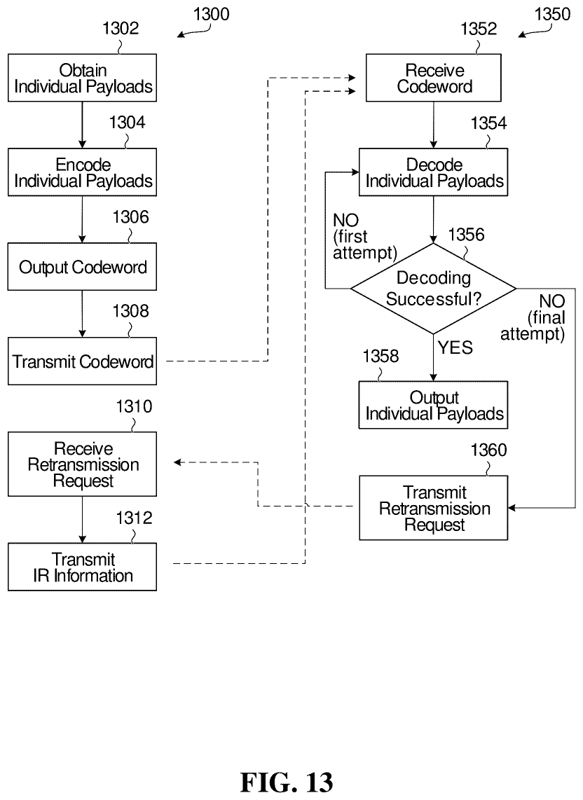

Various aspects of the present disclosure are described above and shown in the drawings by way of example. FIG. 13 is a flow diagram illustrating more general example methods according to embodiments. At the left, 1300 in FIG. 13 illustrates operations or features that may be provided or supported at an encoder or transmitter-side device, and at the right, 1350 illustrates operations or features that may be provided or supported at a decoder or receiver-side device. For ease of reference, in the following description of FIG. 13, a device at which encoding and/or transmitting features may be implemented or supported is called a first communication device, and a device at which decoding and/or receiving features may be implemented or supported is called a second communication device. Embodiments may involve either or both of such devices.

With reference first to 1300, from a transmitting device perspective the transmitting at 1308 is intended to represent transmitting a codeword by a first communication device to a second communication device in a wireless communication network. The codeword is or includes encoded blocks generated by encoding respective individual payloads with an error correction code. The encoded blocks include a self-decodable encoded block that is decodable independently of other encoded blocks, and is also decodable jointly with one or more of the other encoded blocks.

FIG. 13 also illustrates operations that may be involved in generating a codeword. At 1302, FIG. 13 illustrates obtaining individual payloads, which may be or include data from different devices and/or data associated with different services, for example. Obtaining the payloads at 1302 may involve, for example, collecting or otherwise receiving data outputs from one or more devices and/or services, or accessing payload data in a memory.

1304 is intended to illustrate encoding each of the individual payloads, with an error correction code, to generate a codeword that, as described elsewhere herein, includes encoded blocks corresponding to respective individual payloads. The encoded blocks include a self-decodable encoded block, and may include more than one self-decodable encoded block.

As shown at 1306, a method may also involve outputting the codeword that was generated at 1306. The codeword may be output for storage to memory, and/or transmission at 1308 for example.

In some embodiments, a method may involve obtaining as shown at 1302, encoding as shown at 1304, and outputting as shown at 1306. Other embodiments may involve transmitting a codeword as shown at 1308. These embodiments are not mutually exclusive, and methods may involve obtaining and encoding individual payloads as shown at 1302, 1304, and also transmitting a codeword as shown at 1306.

Joint decodability of a self-decodable encoded block may provide or enable any of various other features disclosed herein. For example, the fact that a self-decodable encoded block is further decodable jointly with one or more of the other encoded blocks of a codeword may enable joint decoding of the one or more of the other encoded blocks based on successful decoding of the self-decodable encoded block independently of the other encoded blocks. This is referred to at least above with reference to FIG. 8 by way of example, as augmented decoding.

A self-decodable encoded block further being decodable jointly with one or more other encoded blocks may also or instead enable joint decoding of the self-decodable encoded block after a decoding failure in decoding the self-decodable encoded block independently of the other encoded blocks. A second attempt, and possibly one or more subsequent attempts, may be made to jointly decode a self-decodable encoded block after a decoding failure, rather than requesting a retransmission after the decoding failure. This is referred to at least above with reference to FIG. 9 by way of example as a HARQ-less approach.

An approach that is also referenced herein by way of example as HARQ-less with IR combining may be generalized, from an encoder or transmitter perspective, as involving receiving a first retransmission request, which may be or include NACK-2 signaling for example, and retransmitting IR information, which may be or include an RV or J-RV for example. In an embodiment, a method may involve receiving at 1310, by a first communication device from a second communication device, a first request for retransmission after decoding failures in decoding a self-decodable encoded block independently of other encoded blocks and in joint decoding of the self-decodable encoded block. Of particular note is that the received request is a first request for retransmission after multiple decoding failures. As illustrated at 1312, a method may also involve retransmitting, by the first communication device to the second communication device in response to the first request for retransmission, IR information for the self-decodable encoded block. Other IR information, for other encoded blocks for example, may also be transmitted at 1312.

Although FIG. 13 illustrates only transmitting IR information at 1312, it should be noted that some embodiments may involve generating and outputting IR information for a self-decodable encoded block in response to receiving a first request for retransmission after decoding failures in decoding the self-decodable encoded block independently of other encoded blocks and in joint decoding of the self-decodable encoded block. The generating and outputting are not separately shown in FIG. 13 to avoid further congestion in the drawing.

Joint decoding of a self-decodable encoded block may be enabled by coupling as disclosed herein. For example, common bits may couple a self-decodable encoded block with each of one or more other encoded blocks that may be used in jointly decoding the self-decodable encoded block.

As described by way of example with reference to FIGS. 11 and 12, common bits from one individual payload or one encoded block may be embedded into or otherwise combined with bits from another individual payload or encoded block. Consider an example of successive embedding of coded bits, in which common bits are successively embedded (or in other words a method may involve embedding common bits) between a self-decodable encoded block and one or more other encoded blocks according to a sequence of the self-decodable encoded block and the one or more other encoded blocks in the codeword. In successive embedding of payload bits as shown in FIG. 11, the common bits have been successively embedded (or in other words a method may involve embedding common bits), between respective individual payloads that are encoded to generate the self-decodable encoded block and one or more other encoded blocks in the codeword, according to a sequence of the respective individual payloads in a combined payload that includes the individual payloads.

Another coupling example disclosed at least above is referred to as multi-to-one embedding, which involves coupling both a self-decodable encoded block and at least one other encoded block to the same further encoded block, so that the self-decodable encoded block is also jointly decodable with two or more other encoded blocks.

For a coded bit embedding embodiment, common bits are embedded (or in other words a method may involve embedding common bits), into one encoded block of two or more encoded blocks with which the self-decodable encoded block is to be jointly decodable, from the self-decodable encoded block and each of the two or more encoded blocks other than the encoded block into which the common bits are embedded or are being embedded.

For individual payload bit multi-to-one embedding, common bits are embedded (or in other words a method may involve embedding common bits), into one of the respective individual payloads that is encoded to generate one encoded block of the two or more encoded blocks with which the self-decodable encoded block is to be jointly decodable. The common bits are from the respective individual payloads that are encoded to generate the self-decodable encoded block and each of the two or more encoded blocks other than the one encoded block.

At 1350, FIG. 13 illustrates various decoding and/or receiving counterparts of the features shown at 1300. From a receiving device perspective, the receiving at 1352 is intended to represent receiving a codeword from a first communication device by a second communication device in a wireless communication network. As in other embodiments, the codeword is or includes encoded blocks generated by encoding respective individual payloads with an error correction code, and in at least this sense the encoded blocks correspond to respective error correction coded individual payloads. The encoded blocks include a self-decodable encoded block that is decodable independently of other encoded blocks, and is also decodable jointly with one or more of the other encoded blocks.

FIG. 13 also illustrates operations that may be involved in decoding a codeword. At 1354, FIG. 13 illustrates decoding, from a codeword that includes encoded blocks corresponding to respective error correction coded individual payloads, the individual payloads. After successful decoding, the individual payloads are output as shown at 1358, for storage to memory and/or further processing for example.

The receiving and decoding at 1352, 1354 may involve different receiving device components or features, but need not be mutually exclusive. Methods may involve receiving a codeword at 1352 and decoding individual payloads from the codeword at 1354.

Decoding at 1354 may involve, for example, decoding the self-decodable encoded block independently of the other encoded blocks, and jointly decoding one or more of the other encoded blocks based on successful decoding of the self-decodable encoded block independently of the other encoded blocks of the plurality of encoded blocks. This is referred to at least above with reference to FIG. 8 by way of example, as augmented decoding. If the decoding is successful, then the individual payloads are output at 1358.

Decoding may also or instead involve jointly decoding the self-decodable encoded block after a decoding failure in decoding the self-decodable encoded block independently of the other encoded blocks of the plurality of encoded blocks. The “NO (first attempt)” label and return arrow from 1356 to 1354 is intended to represent a second attempt, and possibly one or more subsequent attempts, to jointly decode a self-decodable encoded block after a decoding failure, rather than requesting a retransmission after the decoding failure. This is referred to at least above with reference to FIG. 9 by way of example as a HARQ-less approach. If the decoding is successful after the subsequent attempt(s), then the individual payloads are output at 1358.

An approach that is also referenced herein by way of example as HARQ-less with IR combining may be generalized as involving a retransmission request as shown at 1360. A method may involve transmitting at 1360, to a first communication device from a second communication device, a first request for retransmission after decoding failures in decoding a self-decodable encoded block independently of other encoded blocks and in joint decoding of the self-decodable encoded block. This is represented in FIG. 13 by the “NO (final attempt)” label and arrow from 1356. The transmitted request is a first request for retransmission after multiple decoding failures, and may be or include NACK-2 signaling, for example. IR information may be transmitted in response to the first request as shown at 1312, and from a receiving device perspective a method may involve receiving, by a second communication device from a first communication device, IR information for the self-decodable encoded block in response to the first request for retransmission that was transmitted at 1360. IR information may be or include RV or J-RV redundant versions, for example. Other IR information, for other encoded blocks for example, may also be received in response to the request.

The dashed-line arrow from 1312 to 1352 in FIG. 13 is intended to represent transmission and receipt of IR information, and the return of processing to 1352 is intended to illustrate performing incremental redundancy decoding based on IR information that is obtained for the self-decodable encoded block in response to a first request for retransmission after decoding failures in decoding the self-decodable encoded block independently of the other encoded blocks and in joint decoding of the self-decodable encoded block. 1352 refers to receiving a codeword, but in the case of a retransmission the same codeword may or may not again be received. Decoding after a retransmission may also be different, and involve joint decoding by using a previously received codeword in combination with newly received IR information, for example.

The coupling examples provided elsewhere herein may be provided in methods that involve receiving and/or decoding a codeword. Common bits from one individual payload or one encoded block may be embedded into or otherwise combined with bits from another individual payload or encoded block.

From a receiver or decoder perspective, a successive embedding embodiment using coded bits may involve common bits having been successively embedded between a self-decodable encoded block and one or more other encoded blocks according to a sequence of the self-decodable encoded block and the one or more other encoded blocks in the codeword. In successive embedding of payload bits as shown in FIG. 11, the common bits have been successively embedded between respective individual payloads corresponding to the self-decodable encoded block and one or more other encoded blocks in the codeword, according to a sequence of the respective individual payloads in a combined payload that includes the individual payloads.

In multi-to-one embedding, common bits may have been embedded into one encoded block of two or more encoded blocks with which the self-decodable encoded block is to be jointly decodable, from the self-decodable encoded block and each of the two or more encoded blocks other than the encoded block into which the common bits are embedded or are being embedded. For individual payload bit multi-to-one embedding, common bits may have been embedded, into one of the respective individual payloads corresponding to one encoded block of the two or more encoded blocks with which the self-decodable encoded block is to be jointly decodable. The common bits are from the respective individual payloads corresponding to the self-decodable encoded block and each of the two or more encoded blocks other than the one encoded block.

In these coupling or embedding examples, the common bits may be decoded at a receiver or decoder, and accordingly a method may involve decoding such bits for joint decoding.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to, or to cause a processor to, transmit, by a first communication device to a second communication device in a wireless communication network, a codeword that includes encoded blocks generated by encoding respective individual payloads with an error correction code. Programming may also or instead include instructions to, or to cause a processor to, obtain the individual payloads, encode each of the individual payloads with an error correction code to generate a codeword, and output the codeword.

The encoded blocks include a self-decodable encoded block that is decodable independently of other encoded blocks, and is further decodable jointly with one or more of the other encoded blocks.

Embodiments related to apparatus or non-transitory computer readable storage media may include any one or more of the following features, for example, which are also discussed elsewhere herein:
the self-decodable encoded block further being decodable jointly with one or more of the other encoded blocks enables joint decoding of the one or more of the other encoded blocks based on successful decoding of the self-decodable encoded block independently of the other encoded blocks;
the self-decodable encoded block further being decodable jointly with one or more of the other encoded blocks enables joint decoding of the self-decodable encoded block after a decoding failure in decoding the self-decodable encoded block independently of the other encoded blocks;
the programming further includes instructions to, or to cause the processor to, receive, by the first communication device from the second communication device, a first request for retransmission, such as NACK-2 signaling for example, after decoding failures in decoding the self-decodable encoded block independently of the other encoded blocks and in joint decoding of the self-decodable encoded block;
the programming further includes instructions to, or to cause the processor to, retransmit, by the first communication device to the second communication device in response to the first request for retransmission, incremental redundancy information such as an RV or a J-RV for the self-decodable encoded block;

the programming further includes instructions to, or to cause the processor to, generate and output incremental redundancy information for the self-decodable encoded block in response to a received first request for retransmission after decoding failures in decoding the self-decodable encoded block independently of the other encoded blocks and in joint decoding of the self-decodable encoded block;
common bits couple the self-decodable encoded block with each of the one or more of the other encoded blocks;
the common bits have been successively embedded between the self-decodable encoded block and the one or more of the other encoded blocks according to a sequence of the self-decodable encoded block and the one or more of the other encoded blocks in the codeword;
the programming further includes instructions to, or to cause the processor to, successively embed the common bits between the self-decodable encoded block and the one or more of the other encoded blocks according to a sequence of the self-decodable encoded block and the one or more of the other encoded blocks in the codeword;
the common bits have been successively embedded, between the respective individual payloads that are encoded to generate the self-decodable encoded block and the one or more of the other encoded blocks in the codeword, according to a sequence of the respective individual payloads in a combined payload that includes the individual payloads;
the programming further includes instructions to, or to cause the processor to, successively embed the common bits between the respective individual payloads that are encoded to generate the self-decodable encoded block and the one or more of the other encoded blocks in the codeword, according to a sequence of the respective individual payloads in a combined payload that includes the individual payloads;
the one or more of the other encoded blocks includes two or more encoded blocks;
the common bits have been embedded, into one encoded block of the two or more encoded blocks, from the self-decodable encoded block and each of the two or more encoded blocks other than the one encoded block;
the programming further includes instructions to, or to cause the processor to, embed the common bits into one encoded block of the two or more encoded blocks, from the self-decodable encoded block and each of the two or more encoded blocks other than the one encoded block;
the common bits have been embedded, into one of the respective individual payloads that is encoded to generate one encoded block of the two or more encoded blocks, from the respective individual payloads that are encoded to generate the self-decodable encoded block and each of the two or more encoded blocks other than the one encoded block;
the programming further includes instructions to, or to cause the processor to, embed the common bits into one of the respective individual payloads that is encoded to generate one encoded block of the two or more encoded blocks, from the respective individual payloads that are encoded to generate the self-decodable encoded block and each of the two or more encoded blocks other than the one encoded block.

Programming stored in or on a non-transitory computer readable storage medium may also or instead include instructions to, or to cause a processor to, receive, from a first communication device by a second communication device in a wireless communication network, a codeword that includes encoded blocks corresponding to respective error correction coded individual payloads. Programming may also or instead include instructions to, or to cause a processor to: decode, from a codeword that includes encoded blocks corresponding to respective error correction coded individual payloads, the individual payloads; and output the individual payloads.

The encoded blocks include a self-decodable encoded block that is decodable independently of other encoded blocks, and is further decodable jointly with one or more of the other encoded blocks.

Embodiments related to apparatus or non-transitory computer readable storage media may include any one or more of the following features, for example, which are also discussed elsewhere herein:
the programming includes instructions to, or to cause a processor to, decode the individual payloads by: decoding the self-decodable encoded block independently of the other encoded blocks of the plurality of encoded blocks, and jointly decoding the one or more of the other encoded blocks based on successful decoding of the self-decodable encoded block independently of the other encoded blocks;
the programming includes instructions to, or to cause a processor to, decode the individual payloads by: jointly decoding the self-decodable encoded block after a decoding failure in decoding the self-decodable encoded block independently of the other encoded blocks of the plurality of encoded blocks;
the programming further includes instructions to, or to cause a processor to, transmit, by the second communication device to the first communication device, a first request for retransmission, such as NACK-2 signaling, after decoding failures in decoding the self-decodable encoded block independently of the other encoded blocks and in joint decoding of the self-decodable encoded block;
the programming further includes instructions to, or to cause a processor to, receive, by the second communication device from the first communication device, incremental redundancy information such as an RV or a J-RV for the self-decodable encoded block in response to the first request for retransmission;
the programming further includes instructions to, or to cause a processor to, perform incremental redundancy decoding based on incremental redundancy information obtained for the self-decodable encoded block in response to a received first request for retransmission after decoding failures in decoding the self-decodable encoded block independently of the other encoded blocks and in joint decoding of the self-decodable encoded block;
common bits couple the self-decodable encoded block with each of the one or more of the other encoded blocks;
the common bits have been successively embedded between the self-decodable encoded block and the one or more of the other encoded blocks according to a sequence of the self-decodable encoded block and the one or more of the other encoded blocks in the codeword;
the programming further includes instructions to, or to cause a processor to, successively embed the common bits between the self-decodable encoded block and the one or more of the other encoded blocks according to a sequence of the self-decodable encoded block and the one or more of the other encoded blocks in the codeword;
the common bits have been successively embedded, between the respective individual payloads corresponding to the self-decodable encoded block and the one or more of the other encoded blocks in the codeword, according to a sequence of the respective individual payloads in a combined payload that includes the individual payloads;
the programming further includes instructions to, or to cause a processor to, successively embed the common bits between the respective individual payloads corresponding to the self-decodable encoded block and the one or more of the other encoded blocks in the codeword, according to a sequence of the respective individual payloads in a combined payload that includes the individual payloads;
the one or more of the other encoded blocks includes two or more encoded blocks;
the common bits have been embedded, into one encoded block of the two or more encoded blocks, from the self-decodable encoded block and each of the two or more encoded blocks other than the one encoded block;
the programming further includes instructions to, or to cause a processor to, embed the common bits into one encoded block of the two or more encoded blocks, from the self-decodable encoded block and each of the two or more encoded blocks other than the one encoded block;
the common bits have been embedded, into one of the respective individual payloads corresponding to one encoded block of the two or more encoded blocks, from the respective individual payloads corresponding to the self-decodable encoded block and each of the two or more encoded blocks other than the one encoded block;
the programming further includes instructions to, or to cause a processor to, embed the common bits into one of the respective individual payloads corresponding to one encoded block of the two or more encoded blocks, from the respective individual payloads corresponding to the self-decodable encoded block and each of the two or more encoded blocks other than the one encoded block.

Embodiments disclosed herein encompass various aspects of what may be referred to as intra-UE MA coding.

Multiple payloads are encoded into a joint codeword, that includes one or more self-decodable shorter codewords.

According to an augmented decoding approach, after successful decoding of a self-decodable codeword, the code rate of at least one other self-decodable codeword can be reduced, therefore potentially resulting in improved performance by increasing the likelihood of correctly decoding the other self-decodable codeword.

If a self-decodable codeword fails to decode, then instead of requesting a retransmission right away, a receiver can proceed to decode another self-decodable codeword. If the latter self-decodable codeword is successfully decoded, then the code rate of the former (failed decoding) codeword can be reduced, potentially resulting in improved performance.

In some embodiments, only if the above second (and possibly further subsequent) decoding attempts fails again, the receiver requests retransmission, using incremental redundancy HARQ for example.

Multiple payloads are encoded into a long code word, where (in various embodiments):
one payload, several payloads, or all payloads are self-decodable after receiving only a subset of a joint codeword that contains all of the coded information of that payload;
all or some bits of a payload that is to be encoded into a shorter code may be embedded into or otherwise combined with bits of another payload, to be encoded into a longer code;
the code rate of an (embedding) shorter code is smaller than the code rate of the (embedded) longer code;
embedding can be progressively performed or, as referenced herein successively performed, as Code1→Code2→Code3→. . . , for example;
embedding can also or instead be multi-to-one, for example Code1→CodeX, Code2→CodeX, Code3→CodeX . . .

Potential advantages may include, for example, any one or more of the following:
Resilience in the sense of providing a capability to recover quickly from multiple decoding failures compared to retransmission-based approaches;
Supplying multiple services with diverse KPI requirements—for example, code rate design may be used to help ensure extra reliability of URLLC over eMBB;
Lower latency relative to IR-HARQ, in that disclosed HARQ-less techniques can potentially avoid higher latency associated with IR-HARQ;
Better performance, in that URLLC performance may be enhanced significantly after a second (or subsequent) decoding attempt but with eMBB performance almost remaining the same as standalone decoding in embodiments such as those shown in FIGS. 8-10 with URLLC decoding and mMTC decoding being attempted first;
Flexibility, in that any of various embedding approaches may be supported to meet different QoS requirements, for example.

Embodiments may be applied to a wide range of communication networks, such as 5G+, 6G, WiFi, non-terrestrial networks (NTNs) and distributed or self-organized networks.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
obtaining a plurality of individual payloads;
encoding each of the individual payloads with an error correction code to generate a codeword, the codeword comprising a plurality of encoded blocks, each encoded block corresponding to a respective individual payload of the plurality of individual payloads, and the plurality of encoded blocks comprising a self-decodable encoded block; and
outputting the codeword,
the self-decodable encoded block being decodable independently of other encoded blocks of the plurality of encoded blocks, and
the self-decodable encoded block further being decodable jointly with one or more of the other encoded blocks of the plurality of encoded blocks of the codeword.

2. The method of claim 1, wherein the self-decodable encoded block further being decodable jointly with one or more of the other encoded blocks enables joint decoding of the one or more of the other encoded blocks, the joint decoding being based on successful decoding of the self-decodable encoded block independently of the other encoded blocks of the plurality of encoded blocks.

3. The method of claim 1, wherein the self-decodable encoded block further being decodable jointly with one or more of the other encoded blocks enables joint decoding of the self-decodable encoded block after a decoding failure in decoding the self-decodable encoded block independently of the other encoded blocks of the plurality of encoded blocks.

4. The method of claim 1, further comprising:
generating and outputting incremental redundancy information for the self-decodable encoded block in response to a first request for retransmission.

5. The method of claim 1, wherein common bits couple the self-decodable encoded block with each of the one or more of the other encoded blocks, and wherein the common bits are a subset of bits of the self-decodable encoded block, and the subset of bits of the self-decodable encoded block is encoded to generate the one or more of the other encoded blocks.

6. The method of claim 1, wherein common bits couple the self-decodable encoded block with each of the one or more of the other encoded blocks, and wherein the common bits are a subset of bits of an individual payload of the plurality of individual payloads, and the individual payload is encoded to generate the self-decodable encoded block and the subset of bits of the individual payload is encoded to generate the one or more of the other encoded blocks.

7. A method comprising:
receiving, from a first communication device by a second communication device in a wireless communication network, a codeword comprising a plurality of encoded blocks, each encoded block of the plurality of encoded blocks corresponding to a respective error correction coded individual payload, the plurality of encoded blocks comprising a self-decodable encoded block,
the self-decodable encoded block being decodable independently of other encoded blocks of the plurality of encoded blocks, and
the self-decodable encoded block further being decodable jointly with one or more of the other encoded blocks of the plurality of encoded blocks of the codeword.

8. The method of claim 7, further comprising:
transmitting, by the second communication device to the first communication device, a first request for retransmission; and
receiving, by the second communication device from the first communication device, incremental redundancy information for the self-decodable encoded block in response to the first request for retransmission.

9. The method of claim 7, wherein common bits couple the self-decodable encoded block with each of the one or more of the other encoded blocks, and wherein the common bits are a subset of bits of the self-decodable encoded block, and the subset of bits of the self-decodable encoded block is encoded to generate the one or more of the other encoded blocks.

10. The method of claim 7, wherein common bits couple the self-decodable encoded block with each of the one or more of the other encoded blocks, and wherein the common bits are a subset of bits of an individual payload of the respective individual payloads, and the individual payload is encoded to generate the self-decodable encoded block and the subset of bits of the individual payload is encoded to generate the one or more of the other encoded blocks.

11. An apparatus comprising:
at least one processor; and
a non-transitory computer readable storage medium, coupled to the at least one processor, storing programming for execution by the at least one processor, the programming including instructions to:
obtain a plurality of individual payloads;
encode each of the individual payloads with an error correction code to generate a codeword comprising a plurality of encoded blocks, each encoded block corresponding to a respective individual payload of the plurality of individual payloads, and the plurality of encoded blocks comprising a self-decodable encoded block; and
output the codeword,
the self-decodable encoded block being decodable independently of other encoded blocks of the plurality of encoded blocks, and
the self-decodable encoded block further being decodable jointly with one or more of the other encoded blocks of the plurality of encoded blocks of the codeword.

12. The apparatus of claim 11, wherein the self-decodable encoded block further being decodable jointly with one or more of the other encoded blocks enables joint decoding of the one or more of the other encoded blocks, the joint decoding being based on successful decoding of the self-decodable encoded block independently of the other encoded blocks of the plurality of encoded blocks.

13. The apparatus of claim 11, wherein the self-decodable encoded block further being decodable jointly with one or more of the other encoded blocks enables joint decoding of the self-decodable encoded block after a decoding failure in decoding the self-decodable encoded block independently of the other encoded blocks of the plurality of encoded blocks.

14. The apparatus of claim 11, the programming further including instructions to:
generate and output incremental redundancy information for the self-decodable encoded block in response to a first request for retransmission.

15. The apparatus of claim 11, wherein common bits couple the self-decodable encoded block with each of the one or more of the other encoded blocks, and wherein the common bits are a subset of bits of the self-decodable encoded block, and the subset of bits of the self-decodable encoded block is encoded to generate the one or more of the other encoded blocks.

16. The apparatus of claim 11, wherein common bits couple the self-decodable encoded block with each of the one or more of the other encoded blocks, and wherein the common bits are a subset of bits of an individual payload of the respective individual payloads, and the individual payload is encoded to generate the self-decodable encoded block and the subset of bits of the individual payload is encoded to generate the one or more of the other encoded blocks.

17. An apparatus comprising:
at least one processor; and
a non-transitory computer readable storage medium, coupled to the at least one processor, storing programming for execution by the at least one processor, the programming including instructions to:
receive, from a first communication device in a wireless communication network, a codeword comprising a plurality of encoded blocks, each encoded block corresponding to respective error correction coded individual payload, the plurality of encoded blocks comprising a self-decodable encoded block,
the self-decodable encoded block being decodable independently of other encoded blocks of the plurality of encoded blocks,
the self-decodable encoded block further being decodable jointly with one or more of the other encoded blocks of the plurality of encoded blocks of the codeword.

18. The apparatus of claim 17, the programming further including instructions to:
transmit, to the first communication device, a first request for retransmission; and
receive, from the first communication device, incremental redundancy information for the self-decodable encoded block in response to the first request for retransmission.

19. The apparatus of claim 17, wherein common bits couple the self-decodable encoded block with each of the one or more of the other encoded blocks, and wherein the common bits are a subset of bits of the self-decodable encoded block, and the subset of bits of the self-decodable encoded block is encoded to generate the one or more of the other encoded blocks.

20. The apparatus of claim 17, wherein common bits couple the self-decodable encoded block with each of the one or more of the other encoded blocks, and wherein the common bits are a subset of bits of an individual payload of the respective individual payloads, and the individual payload is encoded to generate the self-decodable encoded block and the subset of bits of the individual payload is encoded to generate the one or more of the other encoded blocks.
